(19) United States
(12) Patent Application Publication
(10) Pub. No.: US 2024/0092214 A1
(43) Pub. Date: Mar. 21, 2024

(54) DATA CONNECTION SYSTEM

(71) Applicant: AUDI AG, Ingolstadt (DE)

(72) Inventors: Hendrik GRONAU, Ingolstadt (DE); Tobias ROß, Ingolstadt (DE)

(21) Appl. No.: 18/467,545

(22) Filed: Sep. 14, 2023

(30) Foreign Application Priority Data
Sep. 15, 2022 (DE) 102022123593.9

(51) Int. Cl. B60L 53/66; B60L 53/18

(52) U.S. Cl. CPC B60L 53/66; B60L 53/18

(57) ABSTRACT

A data connection system for a vehicle is provided. The data connection system comprises an electrical charging station for the vehicle, a first adapter in the charging station, a second adapter in the vehicle, and a connection to a network. The first adapter, in operation, converts digital signals from the network into analog signals. The data connection system, in operation, relays the analog signals from the first adapter to the second adapter. The second adapter, in operation, converts the analog signals into digital signals and provides the analog signals to at least one device of the vehicle.

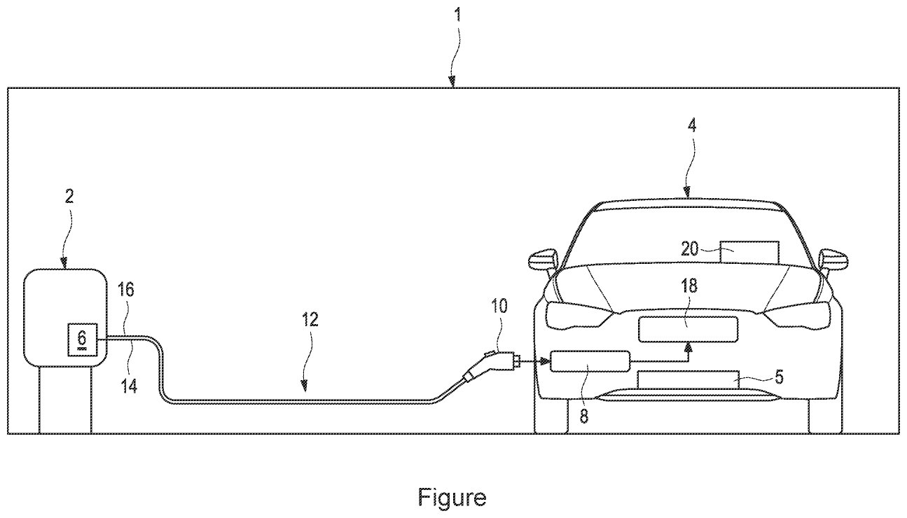

### BACKGROUND

### Technical Field

The disclosure relates to a data connection system and a method for exchanging of data.

### Description of the Related Art

Publication DE 10 2013 219 545 A1 describes a method for charging an energy accumulator of a vehicle at a charging station.

From publication DE 10 2018 115 993 A1 there is known a charging station for charging an electrically powered vehicle with electrical energy.

In publication DE 10 2020 114 144 A1, a charging station for an electric vehicle and a charging infrastructure are described.

### BRIEF SUMMARY

Given this background, embodiments of the disclosure provide techniques to connect a vehicle to the Internet in suitable manner.

The data connection system according to the disclosure is designed for a vehicle, such as a motor vehicle, wherein the data connection system comprises an electrical charging station for the vehicle, a first adapter which is situated in the charging station, and a second adapter which is situated in the vehicle, wherein the charging station comprises a connection to a network, such as the Internet, wherein the first adapter is configured to convert digital signals from the network into analog signals. The data processing system, usually at least one data connection module of the data processing system, is configured to relay the analog signals from the first adapter in the charging station to the second adapter in the vehicle, wherein the second adapter is configured to convert the analog signals into digital signals and provide them to at least one device of the vehicle designed for the data processing.

Furthermore, the second adapter of the vehicle is configured to convert digital signals of the at least one device of the vehicle into analog signals, wherein the data connection module, such as the at least one data connection module, is configured to relay the analog signals from the second adapter to the first adapter of the charging station, wherein the first adapter is configured to convert the analog signals into digital signals and feed them to the network, such as the Internet. The at least one device of the vehicle is connected via the charging station of the data connection system to the network for exchanging data with the network, including with the Internet.

Usually each of the two adapters comprises at least one analog-digital converter and/or at least one digital-analog converter for converting the digital signals into analog signals and/or vice versa, wherein signals which are exchanged with the data connection system between the network and the at least one device of the vehicle contain data, and the data in turn contain information which is transferred by the signals between the at least one device and the network.

The at least one data connection module in one embodiment is wirebound and is generally configured as part of a charging cable between the charging station and the vehicle, the charging cable being designed to transfer electrical energy from the charging station to a battery of the vehicle and being present or provided in any case. A primary current, which is used and/or provided for transporting the electrical energy from the charging station to the battery, can be transferred and thus transported across the charging cable. The charging station is usually hooked up to a public and/or infrastructure-bound and/or device-bound power network, such as a building, the power network being used as the energy source for the battery. Alternatively or additionally, the charging station can be hooked up to a stationary energy accumulator, such as a further battery, which is likewise used as an energy source for the battery.

Moreover, a secondary current is also transferred and thus transported across the charging cable as the at least one data connection module, being intended and/or provided for the exchanging and transporting of the analog signals between the charging station and the battery, also involving electrical analog signals.

Alternatively or additionally, it is possible to transfer the analog signals between the two adapters in radio-supported and/or wireless manner. In this case, at least one adapter among the described adapters comprises an antenna and/or is connected to at least one antenna, while the at least one adapter and/or at least one antenna is designed or designated as an air interface for radio-supported or wireless transfer of the analog signals, for example, according to a wireless local area network (WLAN). Furthermore, it is possible by definition to use air between the adapters and/or antenna as a radio-supported and/or wireless data connection module, serving as a radio-supported and/or wireless data connection module.

The charging cable is arranged to carry out an electrical charging process between the charging station and the vehicle, during which process it connects the charging station and the vehicle. The charging cable comprises a wirebound energy transmission line for the primary current for the transfer of electrical energy from the charging station to the battery of the vehicle.

The at least one data connection module for the secondary current for the exchanging of the analog signals is likewise wirebound and integrated in the charging cable in one embodiment. It is possible to use the energy transmission line already present in the charging cable as and/or for the transfer of the data, while the primary and the secondary current can also be transferred with it, even synchronously, the two currents being superimposed in the energy transmission line.

Alternatively or additionally, it is possible to integrate an additional data line in the charging cable, next to the energy transmission line, for the transfer of the data, this line comprising at least one wire designed or only designed to exchange the secondary current between the two adapters, the energy transmission line being designed solely for the transfer of the primary current. At least one of the lines provided, i.e., the energy transmission line and/or the additional data line, can comprise one wire or multiple parallel wires.

It is possible for the two adapters to be configured or designated as powerline adapters.

The method according to the disclosure is intended for the exchanging of data between a vehicle and a network, such as the Internet, an intranet and/or a home network of a building, with one embodiment of the above-described data connection system. The embodiment of the data connection system comprises an electrical charging station for the vehicle, a first adapter which is situated in the charging station, and a second adapter which is situated in the vehicle, wherein the charging station comprises a connection to the network. Digital signals from the network are converted into analog signals by the first adapter, the analog signals being generally relayed from the first adapter to the second adapter via at least one data connection module, wherein the analog signals are converted by the second adapter into digital signals and provided to at least one device of the vehicle.

For the mutual exchanging of data between the device and the Internet, the digital signals of the at least one device of the vehicle are converted accordingly by the second adapter into analog signals, the analog signals being relayed, generally across the at least one data connection module, from the second adapter to the first adapter, the analog signals being converted by the first adapter into digital signals and furnished to the Internet. The analog signals are relayed between the adapters in wirebound and/or radio-supported manner.

It is proposed that electrical current can flow between the charging station and the vehicle, also in both directions, and a bidirectional charging is possible. Furthermore, it is proposed that electrical energy is transmitted or relayed via a primary current from the charging station across a charging cable to a battery of the vehicle, the analog signals being modulated as an additional secondary current onto the primary current flowing for the transfer of the electrical energy between the charging station and the vehicle, the two currents being transported and/or relayed across a common line, usually the energy transmission line, of the charging cable. During bidirectional charging, electrical energy can be transferred both from the charging station to the battery of the vehicle but also in the reverse, from the battery to the charging station.

Moreover, it is possible for the second adapter to filter out the analog signals from the current which is transferred overall through the charging cable and being also partly intended for the battery, in one embodiment the second adapter drawing a distinction between the primary and the secondary current. This is also possible with the first adapter in the charging station, for example, if the primary current is an alternating current, from which analog signals of the second adapter are filtered out and furnished to the network. Data are exchanged between the network, usually between the Internet, and the at least one device of the vehicle, making use of the charging station already provided for the building, which is arranged in and/or on the building. The building associated with the charging station can be the private home or house of a user of the vehicle or a publicly accessible charging infrastructure having at least one charging station.

With the data connection system, a data connection is provided for the vehicle through the already present charging station, the charging station being used both for the transfer of electrical energy to the battery of the vehicle and as a data charging station.

It is proposed that the charging station comprises a network access, for example, to a home network and/or intranet of a building in which the charging station is located, and/or to the Internet. Through the first adapter as the interface in the charging station, the charging station provides its network access to the vehicle, possibly through an appropriate identifier and/or identification, such as a separate service set identifier (SSID) and/or a password, possibly even for each particular charging process. Thus, the vehicle can access a complete network connection even without its own access to mobile data. For example, a mobile data connection of the vehicle normally used goes down in an underground garage on account of a concrete ceiling of the underground garage. With the data connection system, the vehicle can now reach the Internet as a network through a local are network (LAN) connection of the charging station. The charging station now functions, from a network perspective, as a switch. At least one of the two adapters in the charging station and/or in the vehicle can also be used as a router. It is possible for the second adapter in the vehicle to be given its own Internet protocol (IP) per dynamic host configuration protocol (DHCP) and to be incorporated as a device in a network which is connected to the Internet. The vehicle or the at least one device is connected in wirebound manner to the charging station and thus, through it, to the Internet. For the wirebound connection, the charging cable technically becomes a Gigabit network/LAN cable.

In the case of an alternating current or AC charging process, the secondary current for the transport of data or information can be modulated, for example, with a D-LAN/Power-LAN technology with a frequency of more than 50 Hz provided for this, onto the 50 Hz grid voltage and thus the primary current provided for the transport of the energy. Data are transferred from the first adapter in the charging station to the second adapter in the vehicle, while both adapters can also be designed as powerline communication or PLC adapters.

The first adapter is located in the charging station and can be connected by a LAN cable to a router of the building. The first adapter converts the digital signal, such as an input signal, at first into the analog signal. This goes through the charging cable to the vehicle. The second adapter filters the analog signal out from the charging cable used as the power cable and converts it back into a digital signal, or output signal, with data from the network, such as the Internet. The data of the second adapter, which are present and/or provided, for example, as data packets, are processed by a backend as the device in the vehicle and made available to applications (apps) and/or to the at least one further device in the vehicle, such as a human/machine interface (MMI). The vehicle is connected by the charging station permanently to the network, such as the Internet, and can be reached by its driver during the charging process, if the driver happens to be elsewhere, through an application such as MyAUDI app, whereby the vehicle can be steered remotely, and a data download, a preconditioning of the vehicle, and the providing of a status report are possible.

The vehicle has access to the Internet during the charging process, independently of its own mobile data connection, even if it is situated in a radio dark zone. The permanent wirebound data connection through the charging cable and the charging station is often faster and/or better than a mobile radio connection, depending on the data volume. During the charging process, map material for a navigation device as the device of the vehicle can be updated, for example. Moreover, films, series, and other content from the Internet can be downloaded during the charging process for an upcoming trip. Updates for the device of the vehicle can likewise be loaded. The vehicle can function like a normal device in the home network and thus be used, e.g., as a network storage or network-attached storage or NAS for the transport or safekeeping of data. It can also be enabled as a media storage, where music, films, and/or audio books are downloaded to a vehicle memory as the device. The device of the vehicle can also be incorporated in a home automation of the building. Various programming is conceivable. This includes a control of the building as the home from the vehicle and/or an integration of the vehicle in the automation of the building, such as a house. Thus, the headlights of the vehicle can be used, e.g., to illuminate a front garden or an entry way, when the lighting of the building provided for this purpose is triggered by a motion detector of the building. Moreover, the lights of the vehicle can be integrated for example in a Christmas lighting of the house, for example through an intelligent or smart controller of the lighting of the house. With the proposed data connection system, the vehicle can be incorporated into the Internet of Things.

Of course, the features mentioned above and yet to be explained below can be used not only in the particular indicated combination, but also in other combinations or standing alone, without leaving the scope of the present disclosure.

### BRIEF DESCRIPTION OF THE SEVERAL VIEWS OF THE DRAWINGS

The disclosure is shown schematically in the drawing with the aid of embodiments and shall be described schematically and at length with reference to the drawing.

The FIGURE shows in a schematic representation one embodiment of the data connection system according to the disclosure when carrying out one embodiment of the method according to the disclosure.

### DETAILED DESCRIPTION

The FIGURE shows in a schematic representation a building 1, in which a charging station 2 is situated, with which an electrical battery 5 of a vehicle 4 parked in the building 1, configured here as a motor vehicle, can be charged.

The embodiment of the data connection system according to the disclosure comprises a first adapter 6 in the charging station 2 and a second adapter 8 in the vehicle 4. Moreover, the charging station 2 is hooked up to a power network of an energy provider and also across the first adapter 6, optionally through a home network of the building 1, to the Internet as the network. As a further component, the data connection system comprises a data connection module, which is configured here as a data line 14, being configured next to an energy transmission line 16 in a charging cable 12 for connecting the charging station 2 to the vehicle 4. Furthermore, at one end of the charging cable 12 there is arranged a plug 10, which is compatible with a socket of the vehicle 4.

In the embodiment of the method according to the disclosure, digital signals from the Internet are converted into analog signals by the first adapter 6 in the charging station 2 and relayed via the data line 14 to the second adapter 8 in the vehicle 4, the second adapter 8 converting the analog signals back into digital signals and providing them to at least one device 18, 20 of the vehicle 4. Such a device 18, 20 is provided for the data processing and it is configured for example as a so-called backend or substructure or rear end or human/machine interface. Conversely, digital signals of the at least one device 18, 20 are converted into analog signals by the second adapter 8 and relayed via the data line 14 to the first adapter 6 in the charging station 2, the first adapter 6 converting the analog signals back into digital signals and furnishing them to the Internet. Data can be exchanged mutually between the Internet and the vehicle 4 through the data connection system. Furthermore, it is possible to transfer electrical energy to the battery 5 of the vehicle 4 from the charging station 2 via the energy transmission line 16 of the charging cable 12 and to store it here in synchronized manner, this electrical energy being used for the propulsion of the vehicle 4.

German patent application no. 102022123593.9, filed Sep. 15, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A data connection system for a vehicle, comprising:
an electrical charging station for the vehicle;
a first adapter in the charging station; and
a second adapter in the vehicle,
wherein the charging station includes a connection to a network,
wherein the first adapter, in operation, converts digital signals from the network into analog signals,
wherein the data connection system, in operation, relays the analog signals from the first adapter to the second adapter, and
wherein the second adapter, in operation, converts the analog signals into the digital signals and provides the digital signals to at least one device of the vehicle.

2. The data connection system according to claim 1, wherein the second adapter, in operation, converts second digital signals of the at least one device of the vehicle into second analog signals, wherein a data connection module, in operation, relays the second analog signals from the second adapter to the first adapter, wherein the first adapter, in operation, converts the second analog signals into the second digital signals and provides the second digital signals to the network.

3. The data connection system according to claim 1, comprising at least one data connection module that is part of a charging cable, wherein the at least one data connection module, in operation, transfers electrical energy from the charging station to a battery of the vehicle, or wherein the analog signals are relayed between the first adapter and the second adapter in a radio-supported manner.

4. The data connection system according to claim 3, wherein the at least one data connection module includes an energy transmission line of the charging cable that, in operation, transmits a current of the electrical energy from the charging station to the battery of the vehicle, or wherein the at least one data connection module includes an additional data line integrated in the charging cable with the energy transmission line.

5. The data connection system according to claim 1, wherein the first adapter and the second adapter are powerline adapters.

6. A method for exchanging data between a vehicle and a network, the method comprising:
providing a data connection system, wherein the data connection system includes an electrical charging station for the vehicle, a first adapter in the charging station, a second adapter in the vehicle, and a connection to a network;
converting, by the first adapter, digital signals from the network into analog signals;
relaying the analog signals from the first adapter to the second adapter;
converting, by the second adapter, the analog signals into the digital signals; and
providing, by the second adapter, the digital signals to at least one device of the vehicle.

7. The method according to claim 6, further comprising:
converting, by the second adapter, second digital signals of the at least one device of the vehicle into second analog signals;
relaying the second analog signals from the second adapter to the first adapter;
converting, by the first adapter, the second analog signals into the second digital signals; and
providing, by the first adapter, the second digital signals to the network.

8. The method according to claim 6, further comprising:
transferring electrical energy from the charging station via a charging cable to a battery of the vehicle; and
modulating the analog signals onto a current that flows between the charging station and the vehicle by the transferring.

9. The method according to claim 8, further comprising:
filtering the analog signals from the current.

10. The method according to claim 6, wherein data are exchanged between the vehicle and the Internet as the network.
